(19) United States
(12) Patent Application Publication
(10) Pub. No.: US 2025/0372809 A1
(43) Pub. Date: Dec. 4, 2025

(54) THERMAL RUNAWAY MANAGEMENT LI-ION BATTERY MODULE

(71) Applicant: C-TECH.United Corporation, New Taipei City (TW)

(72) Inventors: CHIH-KUN YANG, New Taipei City (TW); CHIA-HSIN CHEN, New Taipei City (TW)

(73) Assignee: C-TECH.United Corporation, New Taipei City (TW)

(21) Appl. No.: 18/909,017

(22) Filed: Oct. 8, 2024

(30) Foreign Application Priority Data
May 30, 2024 (TW) 113120115

(51) Int. Cl. H01M 50/383; A62C 3/16; H01M 10/0525; H01M 50/213; H01M 50/289; H01M 50/507; H01M 50/60

(52) U.S. Cl. CPC H01M 50/383; A62C 3/16; H01M 10/0525; H01M 50/213; H01M 50/289; H01M 50/507; H01M 50/668

(57) ABSTRACT

Disclosed is a thermal runaway management Li-ion battery module, used in a chassis, comprising: a battery pack, including a plurality of cells; a one-way valve, having a one-way valve flow path and flow separators; a thermally expandable foam member, arranged in the one-way valve flow path; and a flow-limiting member, having a circuitous flow path. The positive terminals of the cells point toward the one-way valve flow path and the thermally expandable foam member, such that the high-temperature substances released by a thermally-runaway cell will enter the one-way valve flow path and cause the thermally expandable foam element to expand and block the one-way valve flow path. This prevents flames and sparks from spreading to the exterior of the chassis, thereby ensuring the safety of surrounding equipment and personnel.

### FIELD OF THE INVENTION

The present invention relates to a battery module, and more particularly relates to a thermal runaway management Li-ion battery module.

### BACKGROUND OF THE INVENTION

The demand for high energy density energy storage systems is on the rise, such as energy storage for electrical grids, backup power for data centers, and electric vehicles. The battery modules of these energy storage systems have various safety requirements based on the environment in which they are used. When thermal runaway occurs in the cells of the battery modules, high-temperature flammable gases and flames are generated. One of the safety requirements for the battery modules is to effectively prevent flames and sparks from spreading out of the chassis that accommodates the battery module during thermal runaway to ensure the overall safety of surrounding devices and personnel.

### SUMMARY OF THE INVENTION

Accordingly, one objective of the present invention is to provide a thermal runaway management Li-ion battery module that prevents flames and sparks from spreading out of the chassis that accommodates the battery module when thermal runaway occurs.

In order to overcome the technical problems in prior art, the present invention provides a thermal runaway management Li-ion battery module, used in a chassis, comprising: a battery pack, including a plurality of cells; a one-way valve, arranged on the battery pack, the one-way valve having a one-way valve flow path and flow separators, the one-way valve flow path having one main flow path and a plurality of side flow paths branching from the main flow path in a tortuous manner with the flow separators formed between the main flow path and the respective side flow paths; a thermally expandable foam member, arranged in the one-way valve flow path; and a flow-limiting member, having a circuitous flow path, one end of the circuitous flow path being connected with an inlet or outlet of the one-way valve flow path, and the other end of the circuitous flow path being connected with an internal space of the chassis, wherein positive terminals of the plurality of cells point towards the one-way valve flow path and the thermally expandable foam member so that high-temperature substances released by the cells in thermal runaway will enter into the one-way valve flow path, causing the thermally expandable foam member to expand and block the one-way valve flow path.

In one embodiment of the present invention, the thermal runaway management Li-ion battery module is provided, wherein the one-way valve is two in number, with the positive terminals of some of the cells point towards the one-way valve flow path of one of the one-way valve, and the positive terminals of the other cells point towards the one-way valve flow path of the other one-way valve.

In one embodiment of the present invention, the thermal runaway management Li-ion battery module is provided, wherein the flow-limiting member is two in number, with one of the flow-limiting members disposed at an inlet side of the one-way valve flow path, and the other flow-limiting member disposed at an outlet side of the one-way valve flow path.

In one embodiment of the present invention, the thermal runaway management Li-ion battery module is provided further comprising an external flame-retardant sheet wrapping the battery pack, the one-way valve, and the thermally expandable foam member.

In one embodiment of the present invention, the thermal runaway management Li-ion battery module is provided, further comprising an internal flame-retardant sheet disposed between a metal conductive sheet of the battery pack and the one-way valve.

In one embodiment of the present invention, the thermal runaway management Li-ion battery module is provided, wherein the one-way valve has a plurality of the one-way valve flow paths.

In one embodiment of the present invention, the thermal runaway management Li-ion battery module is provided, wherein one of the cells is arranged corresponding to only single one of the side flow paths.

In one embodiment of the present invention, the thermal runaway management Li-ion battery module is provided, wherein the battery pack includes a plurality of metal conductive sheets, and for the cells in contact with one of the metal conductive sheets, one of the cells is arranged corresponding to only single one of the main flow paths.

In one embodiment of the present invention, the thermal runaway management Li-ion battery module is provided, wherein the main flow path is a straight flow path.

With the technical means adopted by the thermal runaway management Li-ion battery module of present invention, the one-way valve, which is a non-return valve, is designed to have a flow path arrangement facilitating fluid to flow in the predetermined direction while impeding the fluid from flowing in the reverse direction. Since thermal runaway of the cell often ejects various substances from the positive terminal, the present invention provides the positive terminal of the cell which points towards the one-way valve flow path and the thermally expandable foam member. Accordingly, when thermal runaway of the cell occurs, the high-temperature substances ejected from the positive terminal of the thermal-runaway cell will enter the one-way valve flow path. The one-way valve flow path directs the high-temperature substances in the predetermined direction, the thermally expandable foam member blocks the one-way valve flow path, and the circuitous flow path of the flow-limiting member provides a long path. Such multi-faceted means prevents flames and sparks from spreading out of the chassis, thereby protecting the safety of surrounding personnel and devices.

### BRIEF DESCRIPTION OF THE DRAWINGS

FIG. 1 is a schematic perspective drawing illustrating a thermal runaway management Li-ion battery module according to an embodiment of the present invention used in a chassis;

FIG. 2 is a schematic perspective drawing illustrating a part of the thermal runaway management Li-ion battery module according to the embodiment of the present invention;

FIG. 3 is a schematic exploded drawing illustrating the thermal runaway management Li-ion battery module according to the embodiment of the present invention;

FIG. 4 is a schematic top view illustrating a one-way valve of the thermal runaway management Li-ion battery module according to the embodiment of the present invention;

FIG. 5 is a schematic perspective drawing illustrating a flow-limiting element of the thermal runaway management Li-ion battery module according to the embodiment of the present invention; and

FIG. 6 is a schematic cross-sectional view illustrating the thermal runaway management Li-ion battery module according to the embodiment of the present invention.

### DETAILED DESCRIPTION OF THE PREFERRED EMBODIMENTS

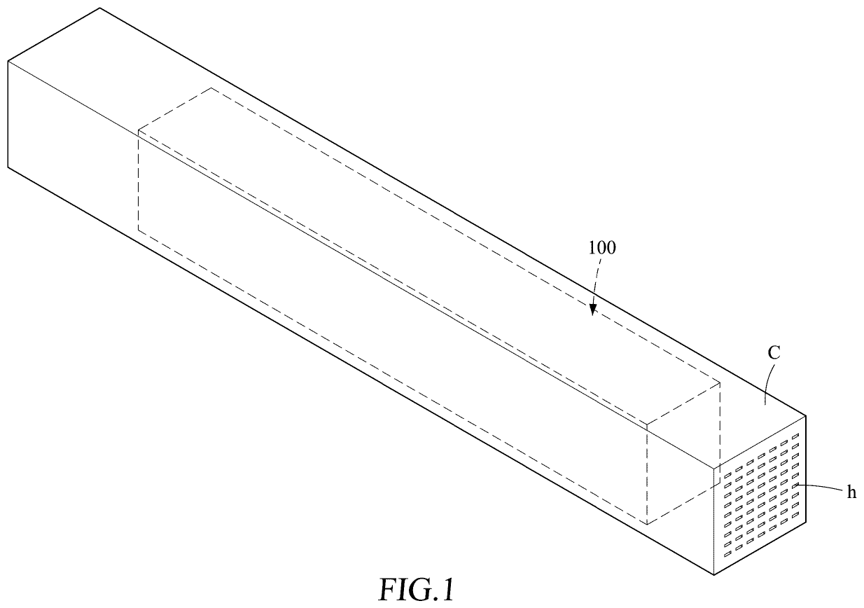

The preferred embodiments of the present invention are described in detail below with reference to FIG. 1 to FIG. 6. The description is used for explaining the embodiments of the present invention only, but not for limiting the scope of the claims.

As shown in FIG. 1, a thermal runaway management Li-ion battery module 100 according to one embodiment of the present invention is used in a chassis C. The chassis C and the thermal runaway management Li-ion battery module 100 inside the chassis C are cooled by a fan (not shown) providing active cooling with a predetermined airflow direction d. The chassis C is provided with ventilation holes h on both sides thereof in the airflow direction d.

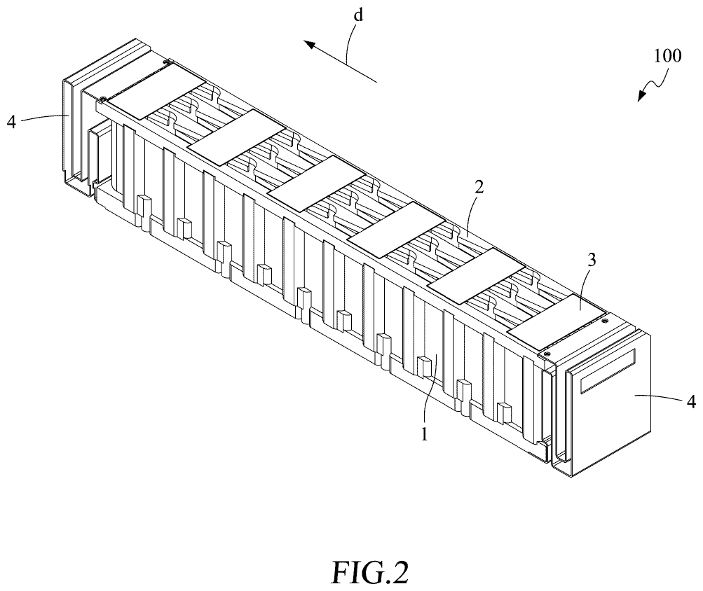

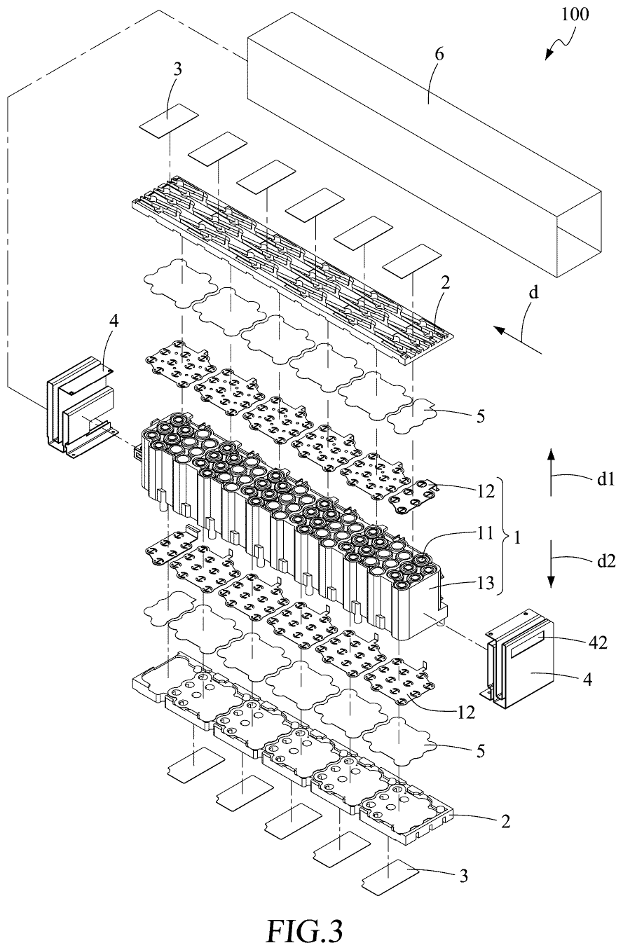

As shown in FIGS. 2 and 3, the thermal runaway management Li-ion battery module 100 includes: a battery pack 1, one-way valves 2, thermally expandable foam members 3, flow-limiting members 4, internal flame-retardant sheets 5, an external flame-retardant sheet 6, and a battery management system (BMS; not shown).

As shown in FIG. 3, the battery pack 1 includes a plurality of cells 11, metal conductive sheets 12, and a cell holder 13.

The cells 11 are disposed in cell accommodating holes of the cell holder 13 and are connected in parallel and/or series through the metal conductive sheets 12. The metal conductive sheets 12 are nickel sheets. The battery management system manages the charging and discharging of the cells 11.

As shown in FIG. 3, in this embodiment, the positive terminals of some of the cells 11 are oriented in a first direction d1 and face one of the one-way valve 2. The positive terminals of the other cells 11 are oriented in a second direction d2 and face the other one-way valve 2. The first direction d1 and the second direction d2 are opposite, and preferably, the first direction d1 and the second direction d2 are perpendicular to the airflow direction d. In other embodiments, all cells may face the same direction, with one one-way valve 2 provided at the positive terminal side of the cells correspondingly.

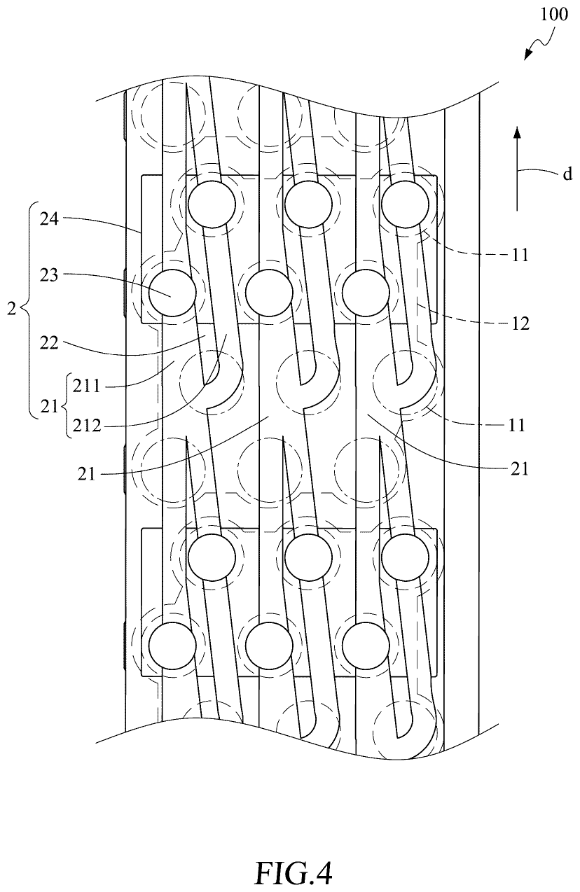

As shown in FIG. 3 and FIG. 4, in the thermal runaway management Li-ion battery module 100 according to the embodiment of the present invention, the one-way valve 2 is arranged on the battery pack 1. The positive airflow direction of the one-way valve 2 is the same as the predetermined airflow direction d. In this embodiment, the one-way valve 2 is made of high thermal conductivity plastic such as Nytex, enabling rapid dispersion of heat from high-temperature materials produced during the thermal runaway and is flame-retardant itself.

The one-way valve 2 has a one-way valve flow path 21 and flow separators 22. In this embodiment, the one-way valve flow path 21 is a groove. The one-way valve flow path 21 and the flow separators 22 are formed on the side of the one-way valve 2 that faces away from the cells 11, and the chassis C covers an outward opening of the one-way valve flow path 21. In other embodiments, the one-way valve flow path 21 can be a flow path embedded within the one-way valve 2.

As shown in FIG. 4, in this embodiment, the one-way valve 2 has three one-way valve flow paths 21, which are not connected to each other. The number of the one-way valve flow paths 21 is determined by the arrangement and number of cells 11.

Each one-way valve flow path 21 has one main flow path 211 and a plurality of side flow paths 212 branching from the main flow path 211 in a tortuous manner with the flow separators 22 formed between the main flow path 211 and the side flow paths 212. The main flow path 211 is less tortuous than the side flow paths 212, and in this embodiment, the main flow path 211 is straight. The side flow paths 212 branch from the same side of the main flow path 211, and in other embodiments, the side flow paths 212 may branch from both sides of the main flow path 211. When the fluid flows in the reverse direction, the fluid exiting the side flow paths 212 creates turbulence in the main flow path 211, impeding the reverse flow of the fluid. The angle between the side flow paths 212 and the main flow path 211 is not limited to that shown in the drawings.

As shown in FIG. 4, the cells 11 indicated by dashed lines indicate their positive terminals pointing out of the paper, and the cells 11 indicated by chain-dot lines indicate their positive terminals pointing into the paper. Each one-way valve flow path 21 has openings 23 corresponding to the positions of the positive terminals of the cell 11, allowing substances ejected during thermal runaway to enter the one-way valve flow path 21.

As shown in FIG. 4, for all cells 11 in contact with a single metal conductive sheet, one cell 11 is arranged corresponding to only one of the side flow paths 212, so that when thermal runaway of the cell 11 occurs, the substances ejected need to bypass the flow separators 22 or enter another side flow path 212 before reaching other cells 11.

Similarly, for all cells 11 in contact with a single metal conductive sheet, one cell 11 is arranged corresponding to only one of the main flow paths 211, so that when thermal runaway of the cell 11 occurs, the substances ejected need to bypass the flow separators 22 and enter another side flow path 212 or travel along the main flow path 211 for the length of one metal conductive sheet 12 before reaching other cells 11.

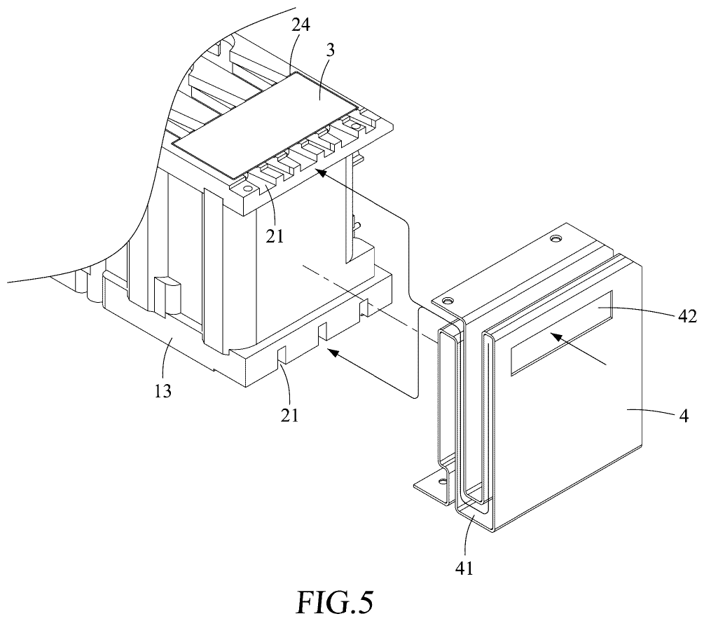

As shown in FIGS. 4 and 5, the thermally expandable foam members 3 are arranged in the one-way valve flow path 21, with the positive terminals of the cells 11 pointing towards the thermally expandable foam members 3. The thermally expandable foam members 3 react at a temperature higher than the operating temperature of the cells 11 but lower than the temperature of the substances produced during thermal runaway. When high-temperature substances from a thermal-runaway cell contact the thermally expandable foam member 3, it causes the volume of the thermally expandable foam member 3 to expand and block the one-way valve flow path 21. In this embodiment, the one-way valve 2 has a thermally expandable material mounting portion 24, which is a groove, and the thermally expandable foam member 3 is accordingly a sheet. The depth of the groove is less than the depth of the one-way valve flow path 21. It goes without saying that the shape of the thermally expandable material mounting portions 24 and the thermally expandable foam members 3 are not limited to this.

As shown in FIG. 5, the flow-limiting member 4 has a circuitous flow path 41. One end of the circuitous flow path 41 is connected to an inlet or outlet of the one-way valve flow path 21 and the other end is connected to an internal space of the chassis C. In this embodiment, both the inlet and outlet sides of the one-way valve flow path 21 are installed with one flow-limiting member 4. FIG. 5 illustrates the flow-limiting member 4 installed on the inlet side of the one-way valve flow path 21, with the arrow indicating the predetermined airflow path.

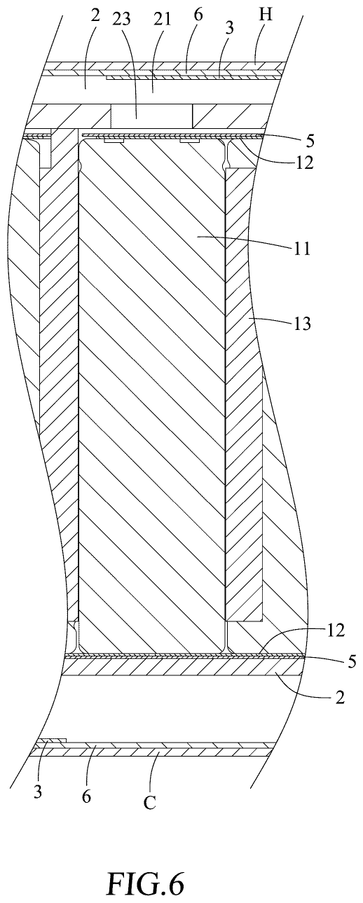

According to an embodiment of the invention, the internal flame-retardant sheet 5 can be YT516 aramid paper or Mylar film, having insulation and flame-retardant properties. As shown in FIGS. 3 and 6, the internal flame-retardant sheet 5 is placed between the metal conductive sheets 12 of the battery pack 1 and the one-way valve 2.

The external flame-retardant sheet 6 can also be YT516 aramid paper or Mylar film, having insulation and flame-retardant properties. As shown in FIGS. 3 and 6, the external flame-retardant sheet 6 wraps the battery pack 1, the one-way valves 2, and the thermally expandable foam members 3.

In summary, as shown in FIG. 6, the positive terminal of cell 11 points upward, with metal conductive sheets 12, internal flame-retardant sheet 5, opening 23 of one-way valve 2, one-way valve flow path 21, thermally expandable foam member 3, external flame-retardant sheet 6, and chassis C sequentially arranged above the positive terminal. When thermal runaway of the cell 11 occurs, the high-temperature substances ejected from the positive terminal of the thermal-runaway cell 11 enter the one-way valve flow path 21 through the opening 23, flow in the predetermined airflow direction d, are blocked by the thermally expandable foam member 3 in the one-way valve flow path 21, and travel through the long path provided by the circuitous flow path 41 of the flow-limiting member 4, thereby preventing flames and sparks from spreading outside the chassis C through multi-faceted means.

The above description should be considered as only the discussion of the preferred embodiments of the present invention. However, a person having ordinary skill in the art may make various modifications without deviating from the present invention. Those modifications still fall within the scope of the present invention.

What is claimed is:

1. A thermal runaway management Li-ion battery module, used in a chassis, comprising:
a battery pack, including a plurality of cells;
a one-way valve, arranged on the battery pack, the one-way valve having a one-way valve flow path and flow separators, the one-way valve flow path having one main flow path and a plurality of side flow paths branching from the main flow path in a tortuous manner with the flow separators formed between the main flow path and the respective side flow paths;
a thermally expandable foam member, arranged in the one-way valve flow path; and
a flow-limiting member, having a circuitous flow path, one end of the circuitous flow path being connected with an inlet or outlet of the one-way valve flow path, and the other end of the circuitous flow path being connected with an internal space of the chassis,
wherein positive terminals of the plurality of cells point towards the one-way valve flow path and the thermally expandable foam member so that high-temperature substances released by the cells in thermal runaway will enter into the one-way valve flow path, causing the thermally expandable foam member to expand and block the one-way valve flow path.

2. The thermal runaway management Li-ion battery module as claimed in claim 1, wherein the one-way valve is two in number, with the positive terminals of some of the cells point towards the one-way valve flow path of one of the one-way valve, and the positive terminals of the other cells point towards the one-way valve flow path of the other one-way valve.

3. The thermal runaway management Li-ion battery module as claimed in claim 1, wherein the flow-limiting member is two in number, with one of the flow-limiting members disposed at an inlet side of the one-way valve flow path, and the other flow-limiting member disposed at an outlet side of the one-way valve flow path.

4. The thermal runaway management Li-ion battery module as claimed in claim 1, further comprising an external flame-retardant sheet wrapping the battery pack, the one-way valve, and the thermally expandable foam member.

5. The thermal runaway management Li-ion battery module as claimed in claim 1, further comprising an internal flame-retardant sheet disposed between a metal conductive sheet of the battery pack and the one-way valve.

6. The thermal runaway management Li-ion battery module as claimed in claim 1, wherein the one-way valve has a plurality of the one-way valve flow paths.

7. The thermal runaway management Li-ion battery module as claimed in claim 1, wherein one of the cells is arranged corresponding to only single one of the side flow paths.

8. The thermal runaway management Li-ion battery module as claimed in claim 6, wherein one of the cells is arranged corresponding to only single one of the side flow paths.

9. The thermal runaway management Li-ion battery module as claimed in claim 1, wherein the battery pack includes a plurality of metal conductive sheets, and for the cells in contact with one of the metal conductive sheets, one of the cells is arranged corresponding to the main flow path.

10. The thermal runaway management Li-ion battery module as claimed in claim 6, wherein the battery pack includes a plurality of metal conductive sheets, and for the cells in contact with one of the metal conductive sheets, one of the cells is arranged corresponding to only single one of the main flow paths.

11. The thermal runaway management Li-ion battery module as claimed in claim 1, wherein the main flow path is a straight flow path.
